(19) United States
(12) Patent Application Publication
(10) Pub. No.: US 2018/0034356 A1
(43) Pub. Date: Feb. 1, 2018

(54) CONSTANTLY VARIABLE TRANSMISSION DEVICE

(71) Applicant: Advanced Hybrid Pty Ltd, Kingsgrove, New South Wales (AU)

(72) Inventor: Michael John Urch, Menai, New South Wales (AU)

(21) Appl. No.: 15/550,542

(22) PCT Filed: Feb. 17, 2016
(86) PCT No.: PCT/AU2016/000043

§ 371 Date: Aug. 11, 2017

(30) Foreign Application Priority Data
Feb. 17, 2015 (AU) 2015900535

(51) Int. Cl. H02K 51/00; B60K 6/30; B60L 11/16; B60L 3/00; B60L 11/18; B60L 11/00; H02K 49/10; H02K 7/11; B60K 6/26; B60L 11/14

(52) U.S. Cl. CPC H02K 51/00; B60K 6/26; B60K 6/30; B60L 11/16; B60L 11/14; B60L 11/1861; B60L 11/005; H02K 49/102; H02K 7/11; B60L 3/0023; B60K 2006/262; B60L 2240/12; B60L 2240/423; B60L 2240/443

(57) ABSTRACT

A variable ratio transmission comprising a rotor including one first set of coils; a second rotor containing first set of iron segments; a third rotor containing second and third set of coils; a fourth rotor containing second set of iron segments; a fifth rotor containing fourth set of coils; the first set of coils in magnetic communication with the first set of iron segments; the first set of iron segments in magnetic communication with the second set of coils; the first, second and third rotors forming a first set of magnetic gears; the third set of coils on the third rotor in magnetic communication with the second set of iron segments on the fourth rotor; the second set of iron segments in magnetic communication with the fourth set of coils; the third, fourth and fifth rotor forming a second set of magnetic gears coupled to the first set of magnetic gears.

### FIELD OF THE INVENTION

The present invention relates to a constantly variable, power transmission device with energy storage for harnessing the kinetic energy from a decelerating vehicle, storing it and supplying this energy to power the vehicle, at a high capacity, as it accelerates.

The invention has been primarily developed for automobile transmissions and gearboxes used in cars. However, it is envisaged that the invention also has other applications such as motor bikes, buses, trucks, trains, and in the generation of electricity in wind turbines and other renewable energy systems.

### BACKGROUND

The price of energy, in particular oil based fuels such as petroleum and diesel that powers most of the vehicles on the road, ocean or air is continually increasing over time. Large sectors of the economy are affected by the rising cost of transportation and governments are continually introducing more rigid environmental standards for emissions control.

As a result, considerable effort and investment has gone into developing hybrid vehicles. These vehicles use the internal combustion engine as a main source of power with power augmented by an electric motor. Other recent developments include electric cars, the performance of which is now comparable to petrol and diesel vehicles. However, the electrical energy used to power the vehicles is stored in batteries which are heavy, expensive and have a limited storage capacity. The operating range of an electric vehicle is accordingly limited and this has constrained the mainstream uptake of these vehicles.

A majority of vehicles, including hybrid and electric, operate in a city environment with large amounts of traffic causing regular stopping and starting of the vehicle. The traditional method to slow down a vehicle is the use of disc or drum brakes that use friction pads to slow the vehicle. A large amount of energy is dissipated as heat during the deceleration process and is effectively wasted. Hybrid vehicles have the ability to operate their electric motors as generators when the vehicle is slowing and often use regenerative braking to reclaim a proportion of the energy normally wasted in braking, store it and then use it to propel the vehicle when it accelerates. However, the electrical storage capacity of such vehicles is limited by the instantaneous capacity of the batteries and at low speeds the changing magnetic flux in the generator reduces to ineffective levels meaning that only small proportions of the overall kinetic energy can be harnessed upon braking.

A recent development in the drive to improve vehicle efficiency has focused on the vehicle transmission or gearbox. Traditional automatic transmissions lose some energy in the torque converter so their efficiency drops. While manual transmissions have more efficient mechanical systems, the driver controlled gear changes usually reduce any gains. Two of the main most recent competing technologies in this field are the double-clutch transmission (DCT) and the constantly variable transmission (CVT). The DCTs are preferred on high performance cars and have very quick gear changes but can be unstable at low speeds. The area of CVT development has evolved from a traditional mechanical gearbox to an electrical gearbox and more recently a magnetic gearbox to fulfil different needs. Current CVTs are typically less efficient than DCTs and are typically limited to small cars so there exists a big opportunity to develop efficient and powerful CVTs for larger applications.

With batteries being the limiting factor, there is no effective method to store large amounts of kinetic energy and release it on demand. CVTs scaled up for higher capacities with integrated mechanical storage would be very attractive to energy-conscious drivers and businesses.

In the wind industry, gearboxes are one of the biggest issues for operating a wind farm. They represent about 15% of all wind turbine failures and changing a gearbox typically takes 3 weeks and approximately US$300,000 for a 3 MW wind turbine. One of the methods to overcome this is to use a direct drive wind turbine. However, due to the slower speeds, generator efficiency is reduced. The generator is also complex and expensive to maintain.

It is the variable speed of the rotor that creates complexity in wind turbines. If power could be supplied to the generator at a fixed speed, then a synchronous generator could be used. This could also alleviate the need for a power converter which currently represents the largest proportion of wind turbine failures at about 27%. Using a CVT gearbox could provide this functionality and has the potential to alleviate most gearbox and power converter failures, amounting to about 42% of all wind turbine failures. A mechanical CVT could not operate under such high loads and, without energy storage, there is no load levelling or effective technique to dampen the wind power spikes or low power levels that are inherent to the operation of a wind turbine. There exists a real opportunity to use a more advanced gearbox and to potentially solve some large and costly issues in the wind industry and other renewable industries.

### OBJECT OF THE INVENTION

It is the object of the present invention to substantially meet one or more of the above needs at least to an extent.

### SUMMARY OF INVENTION

There is disclosed herein a variable ratio transmission device, comprising:

at least one first rotor having an axis of rotation and including at least one first set of coils;

at least one second rotor having an axis of rotation and including at least one first set of iron segments;

at least one third rotor having an axis of rotation and including at least one second set of coils and at least one third set of coils;

at least one fourth rotor having an axis of rotation and including at least one second set of iron segments;

at least one fifth rotor having an axis of rotation and including at least one fourth set of coils;

wherein the at least one first set of coils is arranged in magnetic communication with the at least one first set of iron segments and the at least one first set of iron segments is arranged in magnetic communication with the at least one second set of coils on the same rotor as the at least one third set of coils; the at least one first rotor, at least one second rotor and at least one third rotor being configured to form a first set of magnetic gears; and

wherein the at least one third set of coils on the at least one third rotor is arranged in magnetic communication with the at least one second set of iron segments on the at least one fourth rotor and the at least one second set of iron segments is arranged in magnetic communication with the at least one fourth set of coils, the third rotor, fourth rotor and fifth rotor being configured to form a second set of magnetic gears coupled to the first set of magnetic gears.

Such a device forms a set of two integrated magnetic gears made up of the first, second and third rotors in the first set of magnetic gears and the third, fourth and fifth rotors in the second set of magnetic gears, with the third rotor being common to both. Each of the five rotors is magnetically coupled to its adjacent rotor, whereby the first set of magnetic gears includes an input shaft and an output shaft and is typically used to transmit power with a variable gear ratio to the output shaft, which may be either of the second or third rotors depending on the transmission configuration, as will be described in further detail herein.

Preferably, the second set of magnetic gears includes a flywheel for the mechanical storage of kinetic energy harnessed during braking (in a vehicle application) or at times of excess power (in a wind turbine application). This stored energy can then be supplied back into the transmission device for acceleration of the output shaft or to provide additional power to a generator, depending on the use, at a later time.

Preferably, each of the first and second sets of magnetic gears have at least one chosen rotor that includes an integrated motor/generator having magnets or induction coils and windings for control of the rotor speed via an associated gearbox controller). The gearbox controller ultimately controls the gear ratio of each of the first and second set of magnetic gears. A battery is preferably provided in electrical communication with the gearbox controller. For approximately 50% of the operation of the transmission device, the battery associated with the motor/generator will feed electrical power into the motor/generators to speed up the rotors and for about 50% of the operation it will need to slow them down. During the latter phase of operation, the motor/generator generates power back to the gearbox controller and battery to be stored and used to speed up the rotors later. This arrangement somewhat reduces the power requirements of and increases the efficiency of the transmission device.

The first and second sets of magnetic gears are designed so that if the first set of coils (such as permanent magnets) on the first rotor has N₁ pole pairs and the second set of coils (such as permanent magnets) on the third rotor has N₂ pole pairs then the number of iron segments on the second rotor will have N₃ segments whereby:

N₃=N_{L}+N₂

This same rule applies to both the first and second sets of magnetic gears if maximum efficiency with minimal noise is desired. This sets the intrinsic gear ratio (the gear ratio when the iron segment rotor of the particular magnetic gear is at rest) to be:

Gᵣ=N₁/N₂

When the second rotor is selected as being the rotor that comprises an integrated motor/generator and which thereby has it speed controlled, the speed of the second rotor can be controlled to adjust the operating gear ratio of the magnetic gear according to the following relationship between the speed of the first rotor ω₁, second rotor ω₂ and third rotor ω₃:

ω₁+Gᵣ·ω₂−(1+Gᵣ)ω₃=0

The negative sign in front of the last term of the equation signifies that the third rotor rotates in the opposite direction to the first rotor. To control the operating gear ratio of the magnetic gear, it can be shown that by measuring the speed of the first rotor (assigned as an input shaft) ω₁ and third rotor ω₃ (assigned as an output shaft), and knowing the intrinsic gear ratio Gᵣ, then the speed of the second rotor can be used to control the speed of the third rotor with a variable gear ratio using power input from the first rotor. Similarly, any of the three rotors can be selected as the speed control rotor to control the speed of whichever rotor is assigned as the output rotor with a variable gear ratio achieved via the power input at the input rotor.

When the first set of magnetic gears is combined with the second set of magnetic gears via the third rotor, the transmission device works as a single set of coupled gears such that the operating gear ratio of the first set is controlled by the speed of one of the first or second rotors and the gear ratio of the second set is controlled by the speed of the fourth or fifth rotors. Using a configuration in which the first set of magnetic gears is arranged to transmit power from an engine to a vehicle drive shaft and the second set being arranged to transmit power from the drive shaft to a flywheel power transfer, then the first or second rotor controls the operating gear ratio and ultimately the speed at the drive shaft while the fourth or fifth rotor controls the amount of power added to or taken from the flywheel that is used in regenerative braking vehicle acceleration or load leveling in the application of a wind turbine.

In a preferred embodiment, the first set of magnetic gears is used to transmit power at a variable gear ratio to the assigned output shaft and is coupled with the second set of magnetic gears which are coupled to a flywheel to mechanically store kinetic energy harnessed during braking or power spikes for the supply of this energy back for acceleration or in times of low power. In this parallel arrangement, power mixing, splitting and storage can be achieved in a single device.

In another preferred embodiment, the first set of magnetic gears is a first stage gear set that is used to transmit power at a variable gear ratio to the input to a second stage (or third) set of magnetic gears that is located between the first stage set of magnetic gears and the second set of magnetic gears. The second stage set of magnetic gears transmits power at a variable gear ratio to the output shaft of the second stage set of magnetic gears. In this series arrangement, very high, variable gear ratios can be achieved in a single device such as those required for a wind turbine.

In a preferred embodiment, the axes of rotation of the five rotors of the first and second set of magnetic gears are preferably on the same axis so as to provide concentrically and preferably coaxially configured magnetic gear sets.

In another embodiment, the axes of rotation of twin fifth rotors are arranged perpendicularly to the axes of the other four rotors. The magnetic gears are very forgiving of misalignment and the magnetic flux can be transmitted over a diverse range of rotating styles of gears mimicking and sometimes exceeding the performance of their mechanical counterparts. The rotor axes may accordingly be aligned with the other rotor axes in various configurations such as series, parallel, perpendicular, offset, transverse, split, mixed and at an arbitrary angle for flexible magnetic gearbox designs.

In a preferred embodiment, the first set of magnetic gears is arranged in a configuration having a radial magnetic flux between the first, second and third rotors. The second set of magnetic gears is arranged in an axial flux configuration between the third, fourth and fifth rotors. In this embodiment, the power flow in the first set of magnetic gears is well balanced and transmitted in the radial flux configuration while the axial flux from the flywheel couples to the output shaft in minimal space, highlighting how mixing the configurations within the transmission device can be highly advantageous.

In another embodiment, the second set of magnetic gears includes a pair of fifth flywheel rotors that rotate on a vertical axis perpendicular to the third and fourth rotors. This configuration is advantageous to cancel any large precession forces in the flywheels which is optimal for use in racing cars and other vehicles. The fourth sets of coils on the fifth rotors and iron segments on the fourth rotor can be geometrically designed in stretched and skewed magnetic pole shapes to optimise the magnetic flux transfer on the fourth and fifth rotors.

Each of the sets of coils may be composed of a series of permanent magnets or induction coils excited by their corresponding stator coils.

In a preferred embodiment the coils are composed of permanent magnets installed using a Hallbach Array configuration whereby the magnetic poles may span two, three, four or more magnets. This configuration has the advantage of reducing the number of poles installed on a rotor so that higher gear ratios can be achieved and the majority of the magnetic field is sinusoidal in the air gap for reduced noise and is exerted on a single side which increases magnetic utilisation.

In another embodiment, the coils are composed of permanent magnets installed with the magnet poles being arranged in a traditional north/south configuration. A number of options exist for the number of pole pairs of each of the first, third and fifth rotors as long as the total number of poles follows the rule N₃=N₁+N₂ as described above.

Each of the five or more rotors is rotatably mountable and supported by at least one bearing for hold the rotor substantially fixed in space while allowing free rotation about its axis. The transmission device provides for a range of input shaft and output shaft options. That is, either of the first, second or third rotor could be configured as an input shaft and correspondingly one of the other two rotors as the output shaft. This is advantageous to configure the transmission device for a range of product designs.

In a preferred embodiment, the first rotor is configured as the input shaft, the second rotor is configured as the output shaft and the third rotor is configured as the speed controlled rotor. In this configuration, the input and output shafts rotate in the same direction, which is advantageously compatible with current automobile gearbox configurations.

In another embodiment, the first rotor is configured as the input shaft, the second rotor is configured as the speed controlled rotor and the third rotor is configured as the output shaft. In this configuration the gear ratio is typically a much higher ratio, such as are required for those gearboxes used in wind turbines.

In a preferred embodiment, there is a single input shaft and single output shaft. In another embodiment, there are multiple input shafts all feeding into the magnetic gearbox. This is useful to augment power into a single source.

In another embodiment, there are multiple output shafts all fed from the transmission device. This is useful to supply multiple streams of power from a single source.

In another embodiment, there are multiple input and output shafts all fed into and from the magnetic gearbox. This is useful to supply multiple streams of power from multiple sources.

In a preferred embodiment, the input and output shafts each have rotational speed sensors and preferably torque sensors associated therewith and in electronic communication with the gearbox controller.

The two speed and/or torque sensors are used as feedback into the gearbox controller so that based on the speed requirements accepted from the engine control unit (ECU) and/or driver demands on the accelerator and brake pedals, the gearbox controller can adequately control the speed of the first or second and fourth or fifth rotors to achieve the required gear ratios. The driver sends demands for power and braking and this is used by the gearbox controller to control and ensure that the regenerative braking and acceleration are smooth. The gearbox controller sends and receives power from the battery. It connects to motor/generators on the first or second and fourth or fifth rotors typically by a three-phase connection and is connected to the rotational speed sensors, which may be rotary encoders or Hall sensors. Additional control measures utilise speed and/or torque sensors so that the gearbox controller can accurately predict and set the speeds for the two control rotors. In the case of a wind turbine, the speed of the output shaft is set as a constant and the gearbox controller sets the speeds of the control rotors to ensure that this constant speed is achieved. The controller may also be capable of remote monitoring and control, including the remote tuning of control parameters and output requirements.

In a preferred embodiment, the third rotor and the fifth rotor have their speed controlled to adjust the gear ratios in the transmission device. This configuration is advantageous since the motor/generator coils or permanent magnets on the first and fifth rotors are setup at the extents of the magnetic gearbox and allow easy access to their corresponding stator coils.

In another embodiment, the second rotor and the fourth rotor have their speed controlled to adjust the gear ratios in the magnetic gearbox.

Preferably, an enclosure or casing is arranged to substantially surround or encapsulate the transmission device so as to secure the device to a stable mounting and contain the energy contained therein in the event of a flywheel failure, while allowing at least the input and output shafts to protrude from the enclosure. The input and output shafts may employ seals to close off the transmission device to the environment. However, in normal usage, the various transmission device parts never touch and are lubricant free, therefore seals are typically not required unless a full or partial vacuum is desired in the enclosure.

In an embodiment, the enclosure further includes a non-return valve and a vacuum pump adapted for placing the enclosure and transmission device under a full or partial vacuum. The vacuum reduces any fluid friction on the flywheel as it spins and thereby increases the efficiency of its energy storage. Preferably, the apparatus includes a water jacket arranged outside the transmission device and enclosure. The water jacket absorbs any heat generated inside the transmission device. Alternatively the enclosure may be hermetically sealed, vacuumed to a low internal pressure and a coupling such as a magnetic coupling is provided to transmit power between the inside of the enclosure and an external shaft, thereby eliminating mechanical seals.

In an embodiment, the drive shaft is a drive shaft of a vehicle. In another embodiment, the drive shaft is adapted for driving a compressor. In yet another embodiment, the drive shaft is connected for driving an electrical generator inside a wind turbine.

Preferably, the gearbox controller is a digitally controlled switched brushless motor controller capable of controlling at least two motors and accepting a range of inputs such as driver demands, speed and torque sensor inputs according to a controller program and specific design requirements.

Preferably, the gearbox controller and motor/generators each include a rotor position and speed sensor. More preferably, the gearbox controller includes at least one rotary encoder and/or magnetic hall sensor.

Preferably, the gearbox controller is sufficiently powerful and capable to control the first or second and fourth or fifth rotors in a controlled manner with an appropriate response time to control the gear ratios and meet the transmission power and response time requirements.

Preferably, the energy storage comprises an external electrical power storage device such as a battery or a super capacitor.

Preferably, the coils are permanent magnets. Alternatively, the coils are induction coils, switched reluctance coils or coils capable of generating a magnetic flux.

Preferably, the first, second, third and fourth sets of coils are arranged in a radial flux configuration.

Alternatively, the first, second, third and fourth sets of coils are arranged in an axial, transverse or hybrid flux configuration, or a mixture thereof.

Preferably, the iron segments are composed of laminated electrical steel or soft magnetic composites to lower hysteresis losses and increase efficiency.

Alternatively, the iron segments are solid iron or ferrite bars.

Preferably, external clutches are provided at the input and output shafts to fully decouple the magnetic gearbox from the engine and output shafts.

Alternatively, the speed of the first or second and fourth or fifth rotors in the magnetic gearbox can be controlled at a certain speed to perform a clutching operation so that the output shaft can be at rest while the input shaft is rotating.

Alternatively, a vehicle clutch can be used or other conventional clutching device can be used to decouple the magnetic gearbox from the engine and output shaft.

Alternatively, a magnetic clutch can be installed inside the transmission device to decouple the desired rotors, for example decoupling the transmission device from the flywheel and/or input shaft. The magnetic clutch may typically consist of a thin steel or metal screen that dissipates any magnetic flux as Eddy currents between the rotors in the steel screen and will decouple that rotor from the rotor on the other side of the steel screen. Alternatively, moving the rotors apart so that their air gaps become very large is another form of mechanically actuated magnetic clutch.

### BRIEF DESCRIPTION OF DRAWINGS

Preferred forms of the present invention will now be described by way of example with reference to the accompanying drawings wherein:

FIG. 1a is a half sectional schematic plan view of a first embodiment of a constantly variable transmission device configured in a radial and axial magnetic flux configuration;

FIG. 1b is a schematic side sectional view of a first set of magnetic gears of FIG. 1a;

FIG. 2 is a half sectional schematic plan view of a second embodiment of the transmission device, in which the output shaft is configured to rotate in the same direction as the input shaft;

FIG. 3 is a half sectional schematic plan view of a third embodiment in which the transmission device is advantageously configured so that the motor/generators are at the device extents:

FIG. 4 is a half sectional schematic plan view of a fourth embodiment, in which the transmission device is set up with hybrid flux coils with increased flux density;

FIG. 5 is a half sectional schematic plan view of a fifth embodiment, in which the transmission device is set up with hybrid flux coils with increased flux density and the motor/generators at the device extents;

FIG. 6 is a half sectional schematic plan view of a sixth embodiment, in which the transmission device is set up with twin flywheels rotating in opposite directions; and

FIG. 7 is a half sectional schematic plan view of a seventh embodiment, in which the transmission device includes a first set of magnetic gears and a further (third) set of magnetic gears arranged in series and then coupled to the second set of magnetic gears

### DESCRIPTION OF EMBODIMENTS

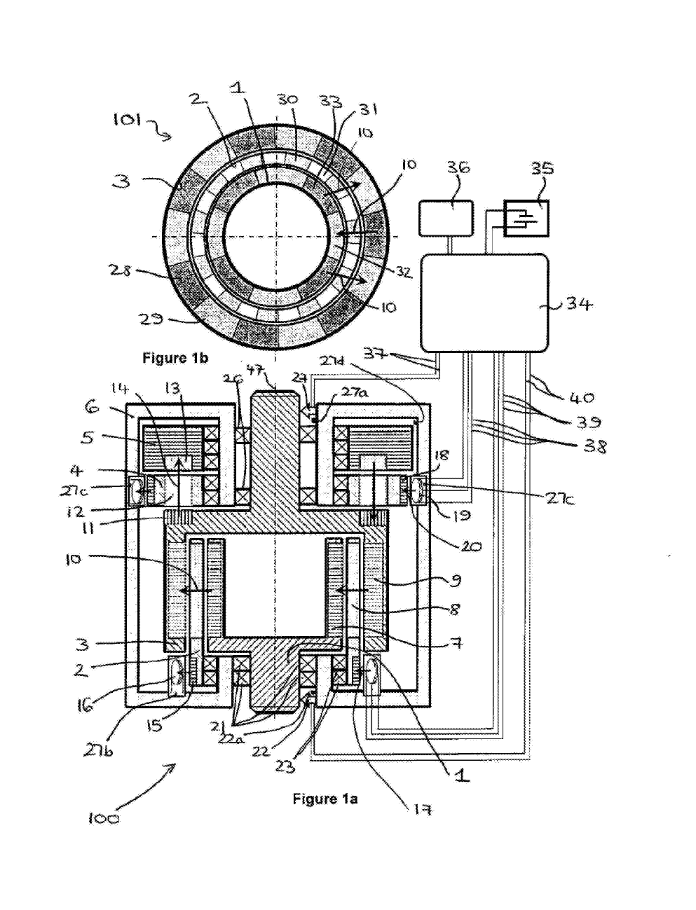

FIG. 1a shows a first embodiment of a constantly variable transmission device 100 with energy storage in half sectional view. The transmission device 100 includes an input shaft 1 as the first rotor, iron segment rotor 2 as the second rotor, output shaft 3 as the third rotor, iron segment rotor 4 as the fourth rotor, and the flywheel 5 as the fifth rotor. The rotors 1, 2, 3, 4 and 5 are all housed inside an enclosure 6 that can be used to secure the device to a stable mounting and minimise damage in the event of failure of the flywheel 5.

In this first embodiment, all five rotors 1, 2, 3, 4, 5 share the same axis of rotation as depicted by the dashed line 47. The first rotor 1 is generally ‘Y’ shaped in section and comprises an input shaft at the input end of the transmission device and a distal annular section. A set of coils 7 is installed on a peripheral surface of the annular section. The first rotor 1 is supported by a set of bearings 21, suitably mounted to allow free rotation of the input shaft 1. The second rotor 2 is supported by a set of bearings 23. The second rotor 2 is also annular, having an internal diameter that is slightly larger than the outer diameter of the annular section of the first rotor 1, such that when the first rotor 1 and the second rotor 2 are mounted concentrically on the same axis of rotation 47, an air gap is present between the two rotors. The third rotor 3 is also ‘Y’ shaped in cross section and its annular section is slightly larger in internal diameter than an external diameter of the second rotor 2, such that an air gap exists between the second rotor 2 and the third rotor 3. The annular section of the rotor 3 terminates in an end face, the output shaft 3 of the transmission device extending distally therefrom. The output shaft 3 is supported by a set of bearings 26.

The third rotor 3 includes a set of coils 11 installed on the end face of the annular section. The fourth rotor 4 is annular in cross section and is mounted on the axis 47 adjacent the end face of the third rotor 3, such that an air gap is present between the two rotors. The fifth rotor is also annular in cross section and is mounted on the axis 47 adjacent the fourth rotor 4, such that an air gap is present between the two rotors. The fourth rotor 4 is supported by a set of bearings 24 and the flywheel 5 is supported by a set of bearings 25.

The input shaft 1 has coils 7 installed on its rotor that are typically powerful rare-earth permanent magnets, preferably arranged in a Hallbach Array to maximise their power. Alternatively, the coils may be induction coils or a mixture thereof. The third rotor/output shaft 3 has similar coils 9 installed on the external surface of the annular section. The number of coils installed on the third rotor 3 is different to the number of coils installed on the annular section of the input shaft 1, in accordance with the design criteria N₃=N₁+N₂ described in the Summary section above. The second shaft 2 has iron segments 8 installed on the rotor so that the magnetic flux as depicted by the arrow 10, can transmit magnetic and ultimately mechanical torque through the magnetic gear at a variable gear ratio. The first set of magnetic gears 101 is shown in side view in FIG. 1b with four pole pairs on the input shaft 1, seven pole pairs (N₂) on the output shaft 3, and using the relationship N₃=N₁+N₂, eleven iron segments on the second rotor 2. This sets the intrinsic gear ratio (Gr) at 1:1.75.

As seen in FIG. 1b, the pole pairs of the rotors 1, 2 and 3 are typically divided into a north pole 32 and a south pole 33 on the first rotor 1, divided into a north pole 28 and a south pole 29 on the third rotor 3, and divided into iron segments 30 and air or non-ferrite segments 31 on the second rotor 2 such that the magnetic flux couples the input shaft 1 with the output shaft 3 in a fixed intrinsic gear ratio (Gr) when the second rotor 2 is stationary, or a variable operating gear ratio according to the speed of the second rotor 2. Hallbach Arrays that have their magnetic poles extending over multiple magnets can be employed to adjust the intrinsic gear ratio (Gr) to higher levels.

In the first set of magnetic gears 101, the set of coils 7 comprises of permanent magnets installed on the input shaft 1 and transmits a magnetic flux 10 into, and out of, the set of iron segments 8 installed on the second rotor 2. The set of iron segments transmits this magnetic flux 10 into, and out of the set of permanent magnets 9 that are installed the third rotor 3. When mechanical torque is applied to the input shaft 1, it is converted into the magnetic flux 10 that produces magnetic torque in the air gaps present between the first set of coils 7 and iron segments 8, and between the iron segments 8 and second set of coils 9. This magnetic torque is converted back into mechanical torque at the output shaft 3. The magnetic flux 10 of the first set of magnetic gears is arranged in a radial flux configuration as shown in FIGS. 1a and 1b.

The second set of magnetic gears comprises of the third rotor 3, the fourth rotor 4 and the fifth rotor 5. The set of coils 11 comprises a set of permanent magnets that is installed on the output shaft 3 and which transmits a magnetic flux 14 into and out of the set of iron segments 12 installed on the fourth rotor 4. The set of iron segments 12 transmits this magnetic flux 14 into and out of the set of permanent magnets 13 that are installed the flywheel 5. When mechanical torque is applied to the output shaft 3, it is converted into the magnetic flux 14 that produces magnetic torque in the air gaps present between the coils 11 and iron segments 12, and between the iron segments 12 and coils 13. This magnetic torque is converted back into mechanical torque at the flywheel 5 for charging the flywheel by speeding it up when in regenerative braking mode, or when power spikes require load leveling, depending on the application. Under acceleration or at times of low power, the flywheel 5 discharges and slows down to transmit power in reverse and supply mechanical torque to the output shaft 3. The magnetic flux 14 of the second set of magnetic gears is in an axial flux configuration as shown in FIG. 1a. Combining a radial flux configuration for the first set of magnetic gears and an axial flux configuration for the second set of magnetic gears allows for greater utilisation of space and infrastructure, making the gearbox more compact and lightweight.

A rotational speed sensor 22 is installed near the input shaft 1 at the input end of the transmission device 100. The speed sensor 22 is coupled to a torque sensor 22a so that speed and torque can be measured. A rotational speed sensor 27 is installed near the output shaft 3. This speed sensor 27 is coupled to a torque sensor 27a so that speed and torque can be measured. Alternatively, if torque sensors are not fitted then the speed sensor 22 monitors the speed of the second rotor 2, and the speed sensor 27 monitors the speed of the fourth rotor 4. The sensors 22, 27 are in electrical communication with a gearbox controller 34. Additional and more accurate control is provided when further speed sensors 27b, 27c installed inside two control motor stators 16 and 19 installed on the enclosure 6 and a further speed sensor 27d installed near the flywheel 5, are also in electrical communication with the gearbox controller 34. Accordingly, the gearbox controller 34 can be configured to ascertain the speed of all five rotors, providing the potential for maximum control for the transmission device 100.

A set of small coils 15 composed of permanent magnets is installed on the second rotor 2. A motor stator or motor generator 16 includes a corresponding set of stator coils 16 mounted on the enclosure 6, adjacent the second rotor 2. The motor generator 16 uses electrical power supplied from the gearbox controller 34 to generate a magnetic flux 17 in a controlled manner to cause rotation of the second rotor 2. The gearbox controller 34 uses the feedback from the speed sensors 27b located inside or near the stator coils 16 to measure the speed of the second rotor 2, following which it employs closed loop control algorithms to send an appropriate amount of power to the stator coils 16, which in turn accurately controls the speed of the second rotor 2. The speed of the second rotor 2 sets the operating gear ratio of the first set of magnetic gears 101 as the ratio between the speed of rotation of the input shaft 1 and the speed of rotation of the output shaft 3.

A set of small coils 18 comprising of permanent magnets is installed on a periphery of the fourth rotor 4. The motor stator or motor generator 19 includes a corresponding set of stator coils mounted on the enclosure 6, adjacent the fourth rotor 4. The motor generator 19 uses electrical power supplied from the gearbox controller 34 to generate a magnetic flux 20 in a controlled manner to cause rotation of the fourth rotor 4. The gearbox controller 34 uses the feedback from the speed sensors 27c located inside or near the stator coils 19 to measure the speed of the fourth rotor 4, following which it employs closed loop control algorithms to send appropriate power to the stator coils 19, which in turn accurately controls the speed of the fourth rotor 4. The speed of the fourth rotor 4 sets the operating gear ratio of the second set of magnetic gears as the ratio between the speed of rotation of the output shaft 3 and the speed of rotation of the flywheel 5. This operating gear ratio is used to charge the flywheel 5 using regenerative braking or during large power spikes and to discharge the flywheel 5 under acceleration or at times of low power by setting the appropriate gear ratio corresponding to the required direction of power transfer.

The gearbox controller 34 is connected to a battery 35 so that power can travel in either direction; that is from the gearbox controller 34 to the battery 35 or vice versa. The gearbox controller 34 is also connected to an engine control unit 36 so that any commands from a vehicle driver, engine and other systems can be communicated to the gearbox controller 34 via the engine control unit 36 and/or directly from a source such as a brake pedal or accelerator pedal of a vehicle. The gearbox controller 34 is connected to the rotational speed sensor 27 using the cables 37, connected to the set of coils of the motor generator 19 using the cables 38, connected to the set of coils of the motor generator 16 using the cables 39, and connected to the rotational speed sensor 22 using the cables 40. Using the large amount of data available from the speed and torque sensors, the gearbox controller 34 is able to process this data and provide the correct power profiles to accurately control the speed of the second rotor 2 and fourth rotor 4 to enable smooth power transfer from the input shaft 1 to the output shaft 3 and smooth power transfer between the output shaft 3 and flywheel 5.

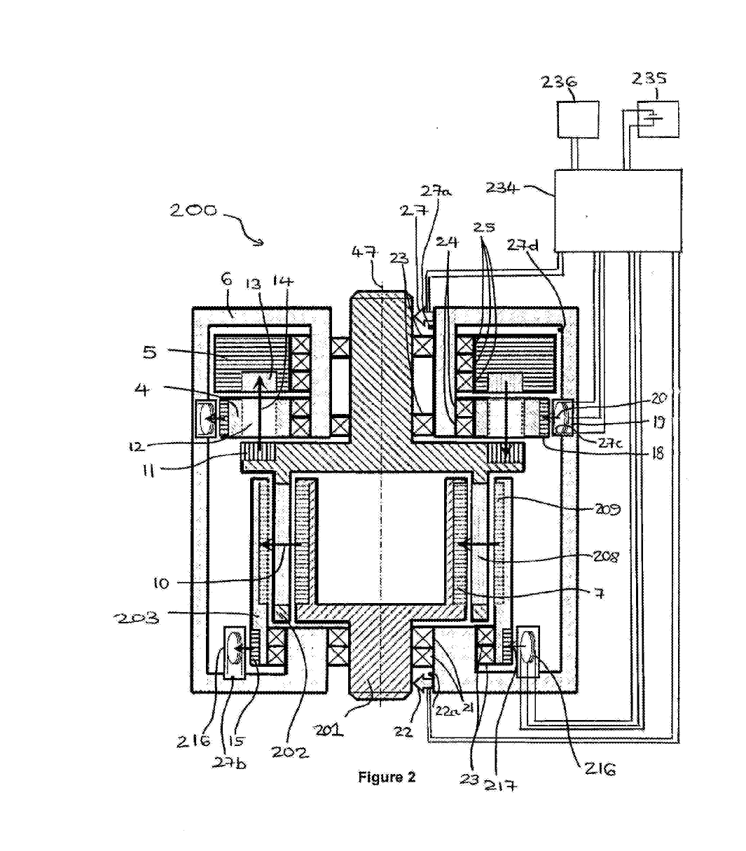

FIG. 2 shows a second embodiment of a constantly variable transmission device 200 in half sectional plan view. The device 200 has many similarities with the device 100 and like components are numbered accordingly. The transmission device 200 is connected to a gearbox controller 234, shown schematically in FIG. 2. In this embodiment, the second rotor 202 and third rotor 203 have been swapped around compared to the embodiment of FIG. 1a. The second rotor 202 having the iron segments 208 installed on it is now configured as the output shaft and is ‘Y’-shaped in section in the same manner as the third rotor 3 of the embodiment of FIG. 1. The third rotor 203 having the permanent magnets 209 installed on it is now configured as the speed controlled rotor and is simply annular in section. The third rotor 203 has its speed controlled via the magnetic flux 217 from a corresponding motor/generator 216. As in the first embodiment, a battery 235 and an engine control unit 236 are connected in two-way electric communication with the gearbox controller 234. The configuration of FIG. 2 advantageously changes the direction of rotation of the output shaft 202 to match the direction of rotation of the input shaft 201, which is the current standard for automobile gearboxes.

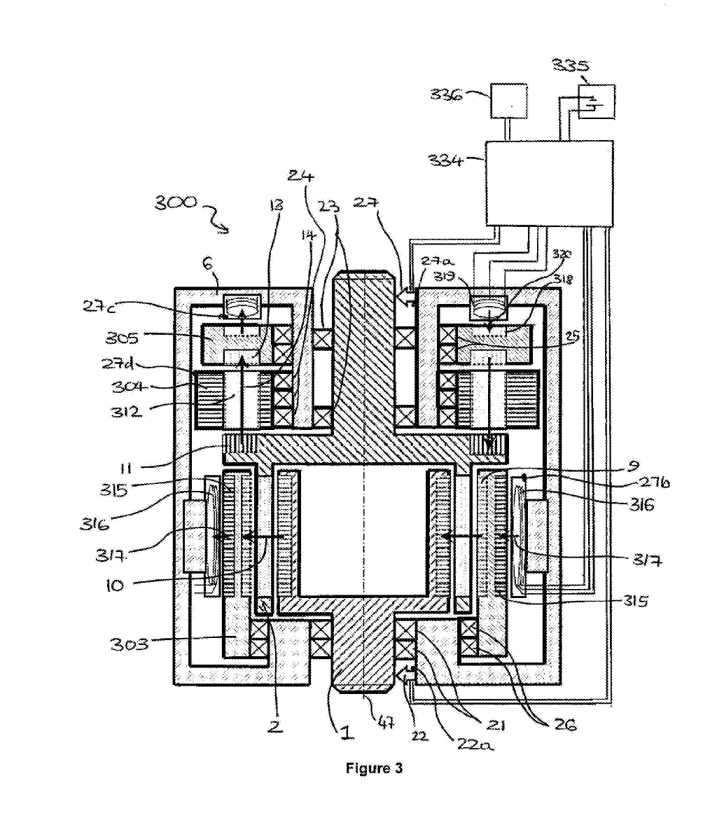

FIG. 3 shows a third and preferred embodiment of a constantly variable transmission device 300 in half sectional plan view. The transmission device 300 is connected to a gearbox controller shown only schematically in the Figure. The rotor configuration of this embodiment is the same as that of FIG. 2 in many respects and like numbers are used for similar components as numbered in FIG. 2. However, the third rotor 303 now accommodates a much larger set of permanent magnets 315 installed in the middle of the outer peripheral face of the third rotor 303. The fourth rotor 304 is now configured as the flywheel with a set of iron segments 312 installed on it. The fifth rotor 305 is now a speed controlled rotor with a set of permanent magnets 318 installed its peripheral outer face. A motor generator is arranged to control the speed of the fifth rotor 305 and comprises of the set of permanent magnets 318 and the stator coils 319, the magnetic flux 320 existing between the coils 319 and magnets 318. A motor/generator is used to control the speed of the third rotor 303 and comprises of the set of permanent magnets 315 and the stator coils 316. A magnetic flux 317 exists between the coils 316 and magnets 315. In this configuration, the third rotor 303 and fifth rotor 305 are used as the speed controlled rotors for the first and second set of magnetic gears respectively. As in the first embodiment, a battery 335 and an engine control unit 336 are connected in two-way communication with the gearbox controller 334. The configuration of FIG. 3 provides significantly more space to install the motor/generators at the transmission device extents which potentially reduces cost and/or increases performance.

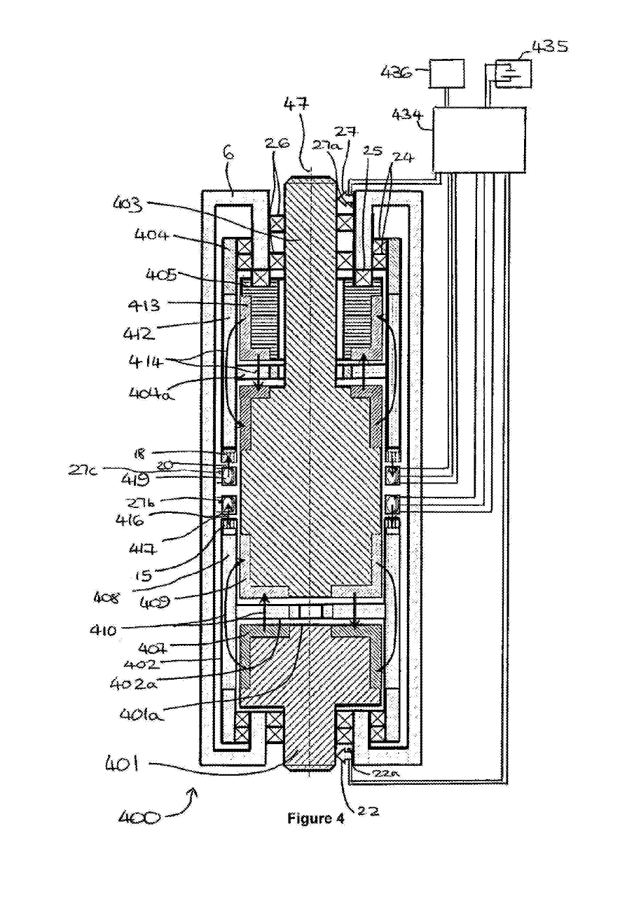

FIG. 4 shows a fourth embodiment of a constantly variable transmission device 400 in a half sectional plan view, shown schematically connected to a gearbox controller 434. Like numbers are used for similar components as numbered in FIG. 1a, however in this embodiment the rotor and coil configuration differs from the previous embodiments. The embodiment includes a first rotor 401 that is configured as the output shaft and is ‘T’ shaped in cross section. The input shaft at a proximal end of the first rotor expands into a short cylindrical section at a distal end of the first rotor 401 and terminates in an end face 401a. The second rotor 402 comprises an annular shaped rotor that has a peripheral wall with an internal diameter that is slightly larger than the external diameter of the short cylindrical section of the first rotor 401. The second rotor 402 is mounted for rotation about the axis 47 such that an air gap exists between the peripheral walls of the two rotors 401, 402. The peripheral wall of the second rotor 402 extends beyond the end face 401a of the first rotor 401. It also includes an inwardly facing annular flange 402a that extends from an internal face of the peripheral wall approximately halfway along the peripheral wall. The flange 402a is positioned adjacent the end face 401a of the first rotor 401 such that an air gap is present between the end face 401a and the flange 402a.

The third rotor 403 is configured as an elongate output shaft having a ‘T’-shaped cross section. The third rotor 403 is mounted on the axis 47 such that a proximal end thereof is positioned adjacent the flange 402a with an air gap present therebetween and such that an outer peripheral wall thereof fits inside the peripheral wall of the second rotor 402 with an air gap therebetween. The second rotor 402 terminates part way along the peripheral wall of the third rotor 403. The third rotor 403 has a cylindrical section that terminates at a distal face, the output shaft extending distally thereform.

The fourth rotor 404 is the same shape and dimensions as the second rotor 402 and is mounted for rotation on the axis 47 so that it fits adjacent the outer peripheral wall of the third rotor 403 with an air gap between the two rotors 403, 404 and so that an inwardly facing annular flange 404a of the fourth rotor 404 fits adjacent the distal face of the third rotor 403 so that an air gap exists between the two rotors 403, 404 also in this orientation.

The fifth rotor 405 is annular and is mounted on the shaft 47 concentrically with the output shaft portion of the rotor 403 and adjacent the annular flange 404a of the fourth rotor 404, such that an air gap is present between the rotors 403 and 404 and 404 and 405 respectively.

The first rotor 401 has a first set of permanent magnets 407 installed on both the end face 401a and at the peripheral face thereof. The second rotor 402 includes a first set of iron segments 408 installed on both the peripheral wall and the annular flange 402a. The third rotor includes a second set of permanent magnets 409 installed at the proximal end thereof adjacent the iron segments 408, and also a third set of permanent magnets 411 installed at the distal face and the distal end of the outer peripheral wall thereof. The fourth rotor 404 includes a second set of iron segments 412 installed along its peripheral wall and annular flange 404a. The fifth rotor 405 includes a fourth set of permanent magnets 413 installed at a proximal end thereof and at the periphery thereof, adjacent the iron segments 412. All four sets of permanent magnets 407, 409, 411 and 413 are setup in a hybrid configuration whereby they can supply magnetic field into the iron segments 408 and 412 in both a radial and an axial direction. The first set of permanent magnets 407 supplies magnetic flux 410 into the iron segments 408 that supply magnetic flux 410 into the second set of permanent magnets 409. The third set of permanent magnets 411 supplies magnetic flux 414 into the iron segments 412 that supply magnetic flux 414 into the fourth set of permanent magnets 413. As in the first embodiment, a battery 435 and an engine control unit 436 are connected in two-way electrical communication with the gearbox controller 434. The hybrid flux configuration of this embodiment can significantly increase the magnetic flux density in the air gap, torque density and capacity of the transmission device.

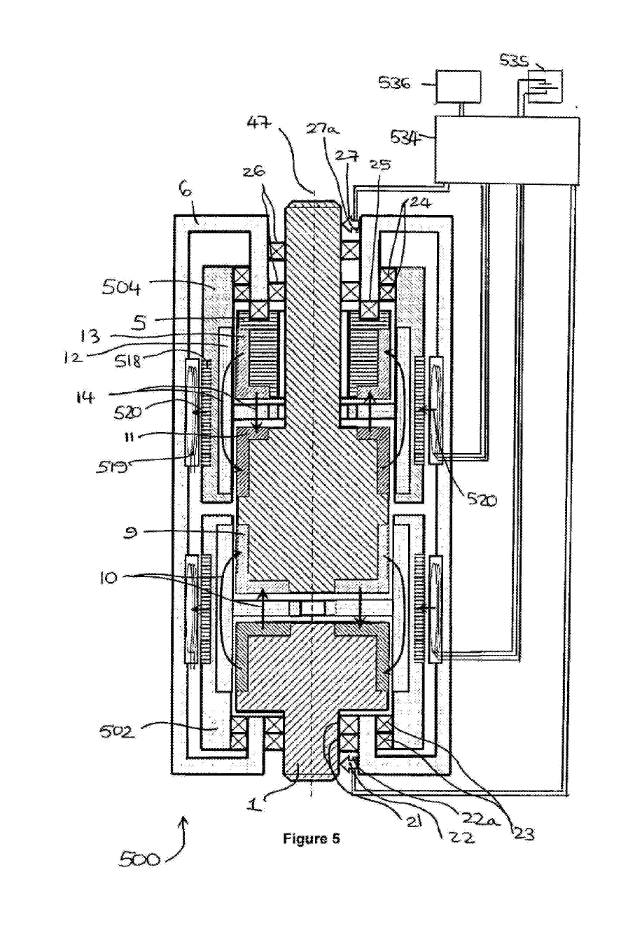

FIG. 5 shows a fifth embodiment of a constantly variable transmission device 500 in half sectional plan view. The transmission device 500 is connected to a gearbox controller 535. The rotor configuration is similar to that of the embodiment of FIG. 4 and like numbers are used for similar components as numbered in FIG. 4, with the exception of the second rotor 502, fourth rotor 504, a set of permanent magnets 515, a set of stator coils 516, magnetic flux 517, a set of permanent magnets 518, a set of stator coils 519 and magnetic flux 520. In this embodiment, the second rotor 502 and fourth rotor 504 each have motor/generators 516, 519 installed on them on the outer face of the rotors 504, 502 respectively. The set of permanent magnets 515 are installed on the second rotor 502 in close proximity to the stator coils 516 that create a magnetic flux 517. Another set of permanent magnets 518 are installed on the fourth rotor 504 in close proximity to the stator coils 519 that create a magnetic flux 520. In this configuration, the motor/generators 516, 519 can utilise a significantly larger space than in previously described embodiments, allowing them to be bigger and more powerful. This is very effective for controlling a hybrid flux magnetic gearbox that is typically very powerful.

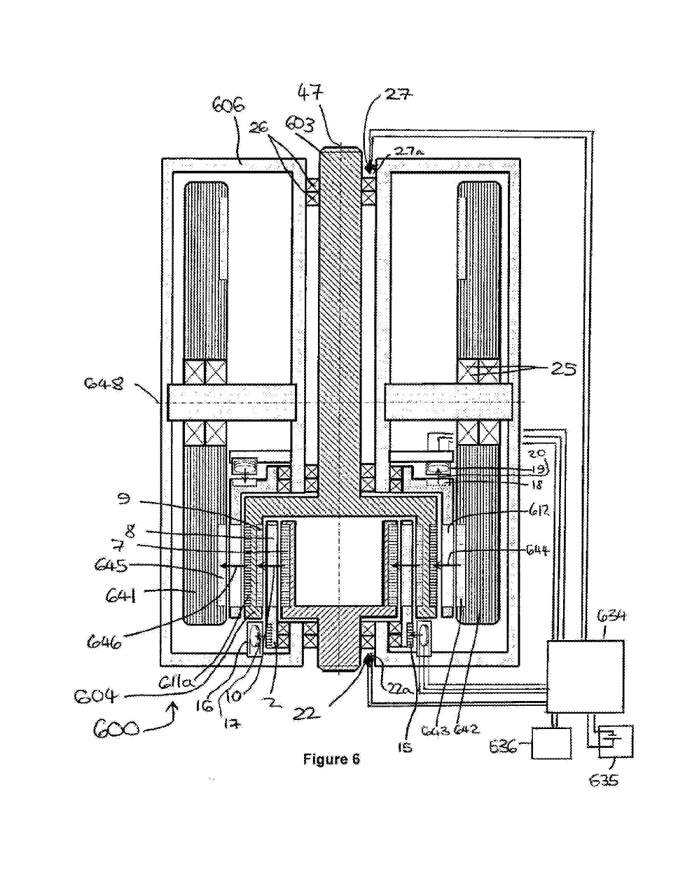

FIG. 6 shows a sixth embodiment of a constantly variable transmission device 600 in half sectional plan view. The transmission device 600 is connected to a gearbox controller 634, shown only schematically. The rotor configuration of the first, second and third rotors is similar to that of the embodiment of FIG. 1a and like numbers are used for similar components as numbered in FIG. 1. However, the third rotor 603, now has an additional second set of permanent magnets 611a installed on it. The fourth rotor 604 is mounted adjacent the third rotor 603 for rotation about the axis 47, that is the same axis as the third rotor 603. The fifth rotor is now divided into a pair of flywheels comprising a first flywheel 641 and a second flywheel 642. The flywheels 641, 642 are each located adjacent the fourth rotor 404 but are now mounted for rotation about an axis of rotation 648 that is perpendicular to the axis 47 about which the third rotor 603 and fourth rotor 604 are mounted. The flywheels 641, 642 each span the length of the transmission device 600. The first flywheel 641 has a first set of permanent magnets 645 installed thereon and the second flywheel 642 has a second set of permanent magnets 643 installed thereon adjacent a set of iron segments 612 installed on the fourth rotor 604.

The set of permanent magnets 611a is installed on a periphery of the third rotor 603 adjacent the set of iron segments 612 installed on the fourth rotor 604. The corresponding magnetic flux is now divided into two areas of the first magnetic flux 646 and second magnetic flux 644, first set of permanent magnets 645 installed on the rotor 641, second set of permanent magnets 643 installed on the rotor 642. The first flywheel 641 and second flywheel 642 rotate about the axis 648 with their corresponding top set of permanent magnets 645 and bottom set of permanent magnets 643 both in magnetic communication with the second set of iron segments 612 so that both flywheels are coupled to the single fourth rotor 604. The set of permanent magnets 611a is magnetically coupled to the set of iron segments 612 which is coupled to both the first set of permanent magnets 645 and the second set of permanent magnets 643 to produce a corresponding first magnetic flux 646 and second magnetic flux 644. The first magnetic flux 646 and second magnetic flux 644 are usually equivalent in magnitude but operate in opposite directions. These magnetic fluxes cause rotation of the first flywheel 641 and second flywheel 642 to be in opposite directions. In normal operation, the speed of the flywheels will be similar so that any precession forces that the flywheels may apply to the enclosure 606 and its mounts can be substantially cancelled out by each flywheel applying a substantially equal but opposite force to their shaft and enclosure 606. This significant reduction or cancellation of precession forces can be highly advantageous in moving vehicles and in particular performance and racing vehicles to reduce any adverse effects to vehicle handling.

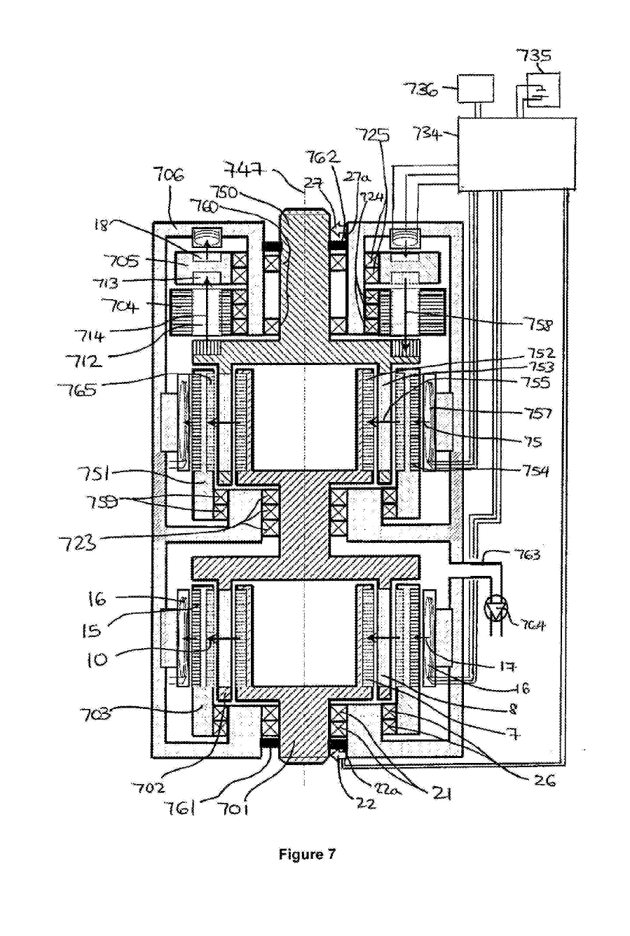

FIG. 7 shows a seventh embodiment of a constantly variable transmission device 700 in half sectional plan view. The transmission device 700 is connected to a gearbox controller 734. Like numbers are used for similar components as numbered in FIG. 3. However, a second set (second stage) of magnetic gears is installed in between the first set of magnetic gears and the flywheel 704. This second stage set of magnetic gears comprises of an input shaft 702 as the first rotor, iron segment rotor 750 as the second rotor and output shaft, third rotor 751 as the controlled rotor i.e. the rotor that is controlled by the gearbox controller 734. This second stage set of magnetic gears then integrates with the energy storage system comprising the flywheel and iron segment rotor 704 as the fourth rotor, and the controlled rotor 705 of the second set of magnetic gears as the fifth rotor. All seven rotors of this embodiment are housed inside an enclosure 706.

In this configuration, the 2-stage gearbox is typically used for gearing up wind turbines from low speeds such as 20 RPM up to about 1,500 RPM. Such a speed up requires a 1:75 gearbox ratio achievable from gear ratios such as 1:8 and 1:9 in the first and second stages of the gearbox respectively. In this configuration, it is advantageous to couple the flywheel 704 with the second stage set of magnetic gears as it is spinning much faster than the first stage set of magnetic gears so that gear ratio between the second stage set of gears and flywheel is significantly reduced which increases efficiency. If a gearbox is required to significantly step down from a high speed such as 1,500 RPM to 20 RPM then the gearbox can be used in reverse by adding torque to the current output shaft 750 which will gear down the speed and supply torque to the current input shaft 1. It will be appreciated by the skilled person that this embodiment can be expanded to incorporate a mixture of two or more stages combined with multiple input and output shafts to achieve very high gear ratios, flexibility and transmitted torque without departing from the basic principle of the embodiment described herein.

All five rotors 702, 750, 751, 704, 705 of the second stage set of magnetic gears and the second set of magnetic gears share the same axis of rotation as depicted by the dashed line 747. The input shaft 702 is supported by a set of bearings 23, suitably mounted to allow free rotation of the input shaft 702. Similarly, the second rotor and output shaft 750 is supported by the set of bearings 760, the control rotor 751 is supported by the set of bearings 59, the fourth flywheel rotor 704 is supported by the set of bearings 24 and the control rotor 705 is supported by the set of bearings 725.

In the second set of magnetic gears, the input shaft 702 has coils 752 installed on its rotor. The controlled rotor 751 has similar coils 765 but a different number from the number of coils installed on the shaft 702 according to the gearbox design. The second rotor 750 also the output shaft from the gearbox, has iron segments 753 installed thereon so that the magnetic flux as depicted by the arrow 755 can transmit magnetic and ultimately mechanical torque through the magnetic gear at a variable gear ratio.

In the second set of magnetic gears, a set of small coils 754 are installed on the third rotor 751, composed of permanent magnets. A corresponding set of stator coils 757 installed an inner wall of enclosure 706 uses electrical power supplied from the gearbox controller (not shown) to generate a magnetic flux 756 in a controlled manner to cause rotation of the third rotor 751. This controlled rotation sets the variable gear ratio for the second set of magnetic gears and second stage of the magnetic gearbox.

In the second set of magnetic gears, a second set of coils 758 are installed on the second rotor for interaction with the fourth rotor and flywheel 704 using the magnetic flux 714 that enters the fourth set of coils 704 or iron segments 712 that transmits the magnetic flux and torque to the fifth set of coils 713 installed on the fifth control rotor 705. The fifth control rotor 705 is speed controlled (as previously described in FIG. 1) to control the operative gear ratio and ultimately the direction and magnitude of power transfer between the flywheel 704 and the output shaft 750.

When used for wind power generation, the magnetic gearbox 700 typically utilises the flywheel 704 as a load leveling device that is able to smooth out the large wind gusts and power spikes while providing additional power when the wind is weak or not blowing at all. If a wind power spike is experienced then the flywheel gear ratio is increased to speed up the flywheel 704 and draw energy from the input shaft 701. When the wind is slow, the flywheel 704 is slowed down to provide power to the output shaft 750. When the wind stops for a long period, then the flywheel 704 can also stop. When the wind starts again, then it is preferable to charge up the flywheel 704 first by accelerating it to near full speed ready to absorb or supply energy depending on the wind speeds and power requirements.

The total operatively gear ratio for this embodiment is carefully controlled by setting an appropriate gear ratio for the first and second set of magnetic gears using their associated control rotors 703 and 759 respectively.

When a flywheel 704 is employed, it is more efficient to operate it in a partial or full vacuum to reduce fluid friction on the flywheel 704 which can cause failure if the rotor speeds are too high. One method is to fully vacuum the air inside the enclosure 706. This can work effectively although small leaks may appear and additional maintenance may be required. A more effective method may be to install mechanical seals 761 and 762 at the juncture between the enclosure 706 and the input 701 and the enclosure 6 and the output shaft 750 respectively. These mechanical seals 761 and 762 and typical low speeds of the shafts 1 and 50 will provide adequate sealing of the enclosure 706. Once the seals 761 and 762 leak then the air pressure sensor (not shown) will detect this and operate the vacuum pump 764 and pull a partial or full vacuum on the enclosure 706 via the suction pipe 763. This will improve the efficiency of the magnetic gearbox 700 and the power used by the vacuum pump 764 should be significantly lower than the power normally lost when not operating in a partial or full vacuum.

In an alternative to the battery 35, 235, 335, 435, 535, 635, 735, the transmission devices 100, 200, 300, 400, 500, 600, 700 may employ a super capacitor as a means of providing external electrical power storage capacity for the gearbox controller 34, 234, 334, 434, 534, 634, 734.

The iron segments are composed of laminated electrical steel or soft magnetic composites. Alternatively they are solid iron or ferrite bars.

External clutches can be provided at the input and output shafts to decouple the transmission device from the engine and output shafts. Alternatively, the rotor speeds can be controlled by the gearbox controller to perform a clutching operation so that the output shaft can be at rest whilst the input shaft rotates.

A magnetic clutch can be installed inside the transmission device to decouple the desired rotors, for example decoupling the transmission device from the flywheel and/or input shaft. The magnetic clutch may typically consist of a thin steel or metal screen that dissipates any magnetic flux as Eddy currents between the rotors in the steel screen and will decouple that rotor from the rotor on the other side of the steel screen. Alternatively, moving the rotors apart so that their air gaps become very large is another form of mechanically actuated magnetic clutch.

Although the invention has been described with reference to specific examples, it will be appreciated by those skilled in the art that the invention may be embodied in many other forms.

1. A variable ratio transmission device with storage, comprising:
a rotor having an axis of rotation and including at least one first set of coils:
a second rotor having an axis of rotation and containing at least one first set of iron segments;
a third rotor having an axis of rotation and containing at least one second set of coils and at least one third set of coils;
a fourth rotor having an axis of rotation and containing at least one second set of iron segments;
a fifth rotor having an axis of rotation and containing at least one fourth set of coils;
wherein the at least one first set of coils is arranged in magnetic communication with the at least one first set of iron segments and the at least one first set of iron segments is arranged in magnetic communication with the at least one second set of coils on the same rotor as the at least one third set of coils; the first rotor, second rotor and third rotor being configured to form a first set of magnetic gears; and
wherein the at least one third set of coils on the third rotor is arranged in magnetic communication with the at least one second set of iron segments on the fourth rotor and the at least one second set of iron segments is arranged in magnetic communication with the at least one fourth set of coils; the third rotor, fourth rotor and fifth rotor being configured to form, second set of magnetic gears that is coupled to the first set of magnetic gears.

2. A variable ratio transmission device as claimed in claim 1, wherein the first set of magnetic gears comprises an input shaft and an output shaft and a speed controlled rotor, wherein a rotational speed of the output shaft is determined by a rotational speed of the input shaft and a rotational speed of the speed controlled rotor for the transmission of power to the output shaft with a variable gear ratio.

3. A variable ratio transmission device as claimed in claim 1, wherein one of the fourth rotor or the fifth rotor of the second set of magnetic gears comprises a flywheel for the mechanical storage of kinetic energy harnessed during operation of the transmission device, and wherein the other of the fourth rotor and the fifth rotor is adapted to be speed controlled, wherein a rotational speed of the flywheel is controllable at least partly according to a rotational speed of the speed controlled rotor.

4. A variable ratio transmission device as claimed in claim 2, wherein the transmission device includes a gearbox controller for controlling the speeds of the speed controlled rotors of the transmission device to adjust the gear ratios between the input shaft and the output shaft of the transmission device;
and for controlling power transfer between the transmission device and an external power storage device.

5. A variable ratio transmission device as claimed in claim 4, wherein the gearbox controller is configured to control the speed of one of the second rotor and the third rotor of the first set of magnetic gears and one of the fourth rotor and the fifth rotor of the second set of magnetic gears to adjust the gear ratios in the transmission device.

6. A variable ratio transmission device as claimed in claim 4, wherein one of the first rotor and the second rotor and one of the fourth rotor and the fifth rotor includes a motor/generator installed thereon, the gearbox controller being in electronic communication with the motor/generator for speed control of the rotor.

7. A variable ratio transmission device as claimed in claim 2, wherein the first rotor is configured as the input shaft, the second roto is configured as the output shaft and the third rotor is configured as the speed controlled rotor.

8. A variable ratio transmission device as claimed in claim 2, wherein the first rotor is configured as the input shaft, the second rotor is configured as the speed controlled rotor and the third rotor is configured as the output shaft.

9. A variable ratio transmission device as claimed in claim 1, wherein each of the first rotor, the second rotor, the third rotor, the fourth rotor and the fifth rotor are concentrically arranged about a common rotational axis.

10. A variable ratio transmission device as claimed in claim 9, wherein the rotors of the first set of magnetic gears are arranged coaxially with the rotors of the second set of magnetic gears.

11. A variable ratio transmission device as claimed in claim 1, wherein the fifth rotor comprises a pair of fifth rotors that are each configured as a flywheel and arranged to rotate about an axis that lies perpendicularly to an axis of rotation of the first, second, third and fourth rotors.

12. A variable ratio transmission device as claimed in claim 1, wherein the first set of coils and the second set of coils of the first set of magnetic gears is arranged to produce radial magnetic flux and the third set of coils and the fourth set of coils of the second set of magnetic gears is arranged to provide an axial flux configuration.

13. A variable ratio transmission device as claimed in claim 1, wherein the first, second, third and fourth sets of coils are arranged in a radial flux configuration or in a hybrid flux configuration.

14. A variable ratio transmission device as claimed in claim 1, wherein the first, second, third and fourth, sets of coils are arranged in an axial, transverse or hybrid flux configuration, or combination thereof.

15. A variable ratio transmission device as claimed in claim 1, wherein each of the first, second, third and fourth sets of coils is a series of permanent magnets, or induction coils adapted for excitation by a corresponding stator coil, switched reluctance coils or coils capable of generating a magnetic flux.

16. A variable ratio transmission device as claimed in claim 15, wherein each of the first, second, third and fourth sets of the coils are permanent magnets installed in a Hallbach Array configuration whereby the magnetic poles of the permanent magnets may span two, three, four or more of the permanent magnets.

17. A variable ratio transmission device as claimed in claim 15, wherein each of the sets of the coils are composed of permanent magnets wherein the magnetic poles of the permanent magnets are installed using a traditional north/south configuration.

18. A variable ratio transmission device as claimed in claim 1, wherein the number of poles of the coils of the first, third and fifth rotors and the number of iron segments of the second and fourth rotors is determined using the equation N₃=N₁+N₂, wherein N₃ is the number of iron segments of the second or fourth rotor, N₁ is the number of pole pairs of the coils of the first or third rotors and N₂ is the number of pole pairs of coils of the third or fifth rotors respectively.

19. A variable ratio transmission device as claimed claim 1, wherein the second rotor of the first set of magnetic gears is a first stage set of magnetic gears in which the output shaft comprises an input shaft into a second stage set of magnetic gears located between the first stage set of magnetic gears and the second set of magnetic gears, whereby the first stage set of magnetic gears is configured to transmit power to the second stage set of magnetic gears at a first variable, gear ratio, wherein the second stage set of magnetic gears includes a sixth rotor configured as a second stage output shaft and a seventh rotor that is adapted to be speed controlled for the transmission of power to the second stage output shaft with a second variable gear ratio.

20. A variable ratio transmission device as claimed in claim 4 wherein the input shaft and the output shaft and/or second stage output shaft each have a rotational speed sensor associated therewith and in electronic communication with the gearbox controller.

21. A variable ratio transmission device as claimed in claim 20, wherein the input shaft and the output shaft and/or second stage output shaft each have a torque sensor associated therewith and in electronic communication with the gearbox controller.

22. A variable ratio transmission device as claimed in claim 20, wherein the gearbox controller and motor/generators each include a rotor position sensor and/or a speed sensor.

23. A variable ratio transmission device as claimed in claim 22, wherein the rotor position sensor and/or speed sensor includes at least one rotary encoder and/or magnetic hall sensor.

24. A variable ratio transmission device as claimed in claim 20, wherein the gearbox controller uses the sensor readings in combination with one or more requirement inputs to control the speed of a rotor.

25. A variable ratio transmission device as claimed in claim 24, wherein the one or more user requirements include one or more of speed requirements received from an engine control unit, user demands communicated via a brake pedal or an accelerator pedal of a vehicle, or wind turbine power load level requirements.

26. A variable ratio transmission device as claimed in claim 4, wherein the gearbox controller is a digitally controlled switched brushless motor controller.

27. A variable ratio transmission device as claimed in claim 4, wherein the gearbox controller is arranged in electrical communication with an external electrical power storage device.

28. A variable ratio transmission device as claimed in claim 27, wherein the external electrical power storage device is a battery or super capacitor.

29. A variable ratio transmission device as claimed in claim 1, further comprising an enclosure or casing for the containment of each of rotors of the transmission device.

30. A variable ratio transmission device as claimed in claim 29, wherein the enclosure includes a non-return valve and a vacuum pump adapted for placing the enclosure under a full or partial vacuum.

31. A variable ratio transmission device as claimed in claim 30, further comprising a water jacket arranged to substantially surround the enclosure or casing.

32. A variable ratio transmission device as claimed claim 30, wherein the enclosure includes seals to prevent contaminants from entering the transmission device.

33. A variable ratio transmission device as claimed in claim 2, wherein the transmission device is adapted to transmit power from a plurality of input shafts to a single output shaft, or from a single input shaft to a plurality of output shafts or combination of both.

34. A variable ratio transmission device as claimed in claim 2, wherein the output shaft is the drive shaft of a vehicle engine or compressor, or wherein the output shaft or second stage output shaft is connected for driving an electrical generator inside a wind turbine.

35. A variable ratio transmission device as claimed in claim 1, wherein the iron segments comprise laminated electrical steel or soft magnetic composites.

36. A variable ratio transmission device as claimed in claim 34, further comprising an external clutch arranged in operable communication with each of the input and output shaft or second stage output shaft for decoupling the transmission device from drive shaft or electrical generators.

37. A variable ratio transmission device as claimed in claim 34, wherein the gearbox controller is configured to control the speed of the first or second and fourth or fifth and/or sixth or seventh rotors is at a certain speed to perforin a clutching operation so that the output shaft or second stage output shaft is a rest whilst the input shaft is rotating.

38. A variable ratio transmission as claimed in claim 34, further comprising a magnetic clutch installed inside the gearbox to decouple the flywheel and/or input shaft from the transmission device.
